(19) United States
(12) Patent Application Publication
(10) Pub. No.: US 2006/0047707 A1
(43) Pub. Date: Mar. 2, 2006

(54) Apparatus and methods for information handling system with wireless communication

(76) Inventor: David T. Dionne, Huntsville, AL (US)

Correspondence Address: O'KEEFE, EGAN & PETERMAN, L.L.P., Building C, Suite 200, 1101 Capital of Texas Highway South, Austin, TX, 78746, US

(21) Appl. No.: 11/153,251

(22) Filed: Jun. 15, 2005

Related U.S. Application Data
(60) Provisional application No. 60/522,173, filed on Aug. 25, 2004.

(51) Int. Cl. G06F 17/30

(52) U.S. Cl. 707/200

(57) ABSTRACT

A system includes an information handling system and a host. The information handling system is configured to communicate with the host, and to exchange information with the host. The information exchange occurs without using an intermediate information exchanger. The information may include e-mail information, calendar information, contacts information, notes information, tasks information, subfolders information, global address list (GAL) information, public folders (or folders generally) information, and/or groupware information.

### CROSS-REFERENCE TO RELATED APPLICATIONS

This application claims priority to, and incorporates by reference, U.S. Provisional Patent Application Ser. No. 60/522,173, filed on Aug. 25, 2004.

### TECHNICAL FIELD

The inventive concepts relate generally to information handling apparatus and systems. More particularly, the invention concerns apparatus and associated methods for providing efficient communication between an information handling system and a remote apparatus.

### BACKGROUND

As the value and use of information continues to increase, individuals and businesses seek additional ways to communicate, process, and store information. One option available to users is information handling systems. Generally speaking, an information handling system generally processes, compiles, stores, and/or communicates information or data for business, personal, or other purposes thereby allowing users to take advantage of the value of the information.

One aspect of information handling systems relates to communication with remote apparatus, such as remote systems or host systems (for example, between a host system and a mobile system). In conventional approaches, typically a server exists on the host system that interacts with a second, often proprietary, server in order to facilitate communication. This two-server approach is inefficient, has a relatively high cost, and often entails use of proprietary software, hardware, and communication protocols.

### SUMMARY

The disclosed novel concepts relate to apparatus and methods for providing efficient communication between two systems or devices. In other words, an information handling system or device according to the invention may communicate with another system or device, without using an intermediate information exchanger or broker (e.g., an intermediate server, system, computer, etc.)

In one embodiment, a system includes an information handling system and a host. The information handling system is configured to communicate with the host, and to exchange information with the host. The information exchange occurs without using an intermediate information exchanger. The information includes groupware information. In variations, the information may include e-mail information, calendar information, contacts information, notes information, tasks information, subfolders information, public folders (or folders generally) information, and/or global address list (GAL) information.

In a second embodiment, an information handling system includes a communication module. The communication module is configured to cause the information handling system to communicate with a second system, and to exchange information with the second, without using a dedicated intermediate information exchanger. The exchanged information may include at least one of e-mail information, calendar information, contacts information, notes information, tasks information, subfolders information, global address lsit (GAL) information, groupware information, and public folders (or folders generally) information.

In another embodiment, a computer program product includes a computer application. The computer application is adapted for processing by a computer. The application is configured to cause the computer to communicate with a host and to exchange information with the host without using an intermediate information exchanger. The exchanged information includes at least one of e-mail information, calendar information, contacts information, notes information, tasks information, subfolders information, global address list (GAL) information, groupware information, and public folders (or folders generally) information.

In yet another embodiment, a method of communicating information between a wireless mobile device and a system includes selecting the information, and communicating the information without using a dedicated intermediary information exchanger. The communicated information includes at least one of e-mail information, calendar information, contacts information, notes information, tasks information, subfolders information, global address list (GAL) information, public folders (or folders generally) information, and groupware information.

### BRIEF DESCRIPTION OF THE DRAWINGS

The appended drawings illustrate only exemplary embodiments of the invention and therefore should not be considered or construed as limiting its scope. Persons of ordinary skill in the art who have the benefit of the description of the invention appreciate that the disclosed inventive concepts lend themselves to other equally effective embodiments. In the drawings, the same numeral designators used in more than one drawing denote the same, similar, or equivalent functionality, components, or blocks.

FIG. 1 shows a generalized block diagram of an information handling system 100 according to an exemplary embodiment of the invention.

FIG. 2 illustrates a simplified arrangement of an information handling system according to an exemplary embodiment of the invention communicating with a remote system.

FIG. 3 depicts a more detailed block diagram of an information handling system according to an illustrative embodiment of the invention communicating with a remote system in a communication arrangement.

FIG. 4 shows a simplified block diagram of an information handling system according to another illustrative embodiment of the invention communicating with a remote system in a communication arrangement.

FIG. 5 illustrates a simplified block diagram of an information handling system according to an illustrative embodiment of the invention.

### DETAILED DESCRIPTION

Generally speaking, an information handling system may include any instrumentality or aggregate of instrumentalities operable to compute, classify, process, transmit, receive, retrieve, originate, switch, store, display, manifest, detect, record, reproduce, handle, communicate, or utilize any form of information, intelligence, or data for business, scientific, control, or other purposes. One example of an information handling system is a computer.

Other examples include a personal computer, a network storage device, a personal digital assistant (PDA), a mobile communication device, such as a mobile telephone or cellular telephone, or any other suitable device and may vary in size, shape, performance, functionality, and price.

As yet other examples, an information handling system may be a converged device or hybrid device, i.e., a device that includes some of the functionality and characteristics of one or more of the preceding devices (e.g., a device with the functionality of a PDA combined with mobile telephony functionality). Some brand-specific examples include the Blackberry by Research in Motion (see http://www.rim.net/ for more information), the Treo Smartphones by palmOne (see http://www.palmone.com/ for more information), etc.

In general, an information handling system may include random access memory (RAM), one or more processing resources such as a central processing unit (CPU) or hardware or software control logic, ROM, and/or other types of nonvolatile memory. Additional components of an information handling system may include one or more storage devices (such as disk drives or flash devices), one or more network ports for communicating with external devices as well as various input and output (I/O) devices, such as a keypad or keyboard, a mouse, touch pad, or touch-sensitive screen, and a display.

The information handling system may also include one or more communication mechanisms, such as buses, operable to transmit communications between the various hardware components. Furthermore, the information handling system may include various ports for attaching to, and communicating with, external devices. An example of such a port includes a universal serial bus (USB) port.

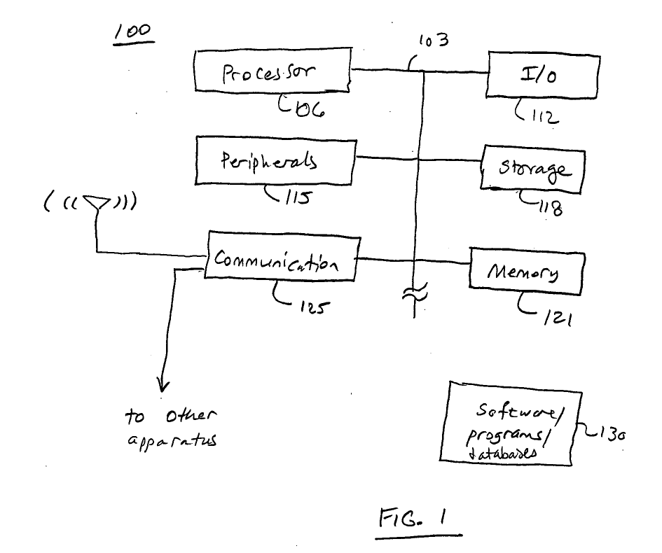

FIG. 1 shows a generalized block diagram of an information handling system 100 according to an exemplary embodiment of the invention. Generally speaking, system 100 may constitute a PDA, a computer system, a mobile communication device, a workstation, and the like, as desired. System 100 includes one or more processors 106, one or more buses or communication media 103, video/graphics hardware 109, storage subsystem 118, memory 121, input/output (I/O) 112, peripherals 115, and communication apparatus 125.

Bus 103 provides a mechanism for the various components of system 100 to communication and couple with one another and thus acts as the backbone of the system. Processor 106, video/graphics 109, storage subsystem 118, memory 121, I/O 112, communications apparatus 125, and peripherals 115 have the structure, and perform the functions, familiar to persons of ordinary skill in the art who have the benefit of the description of the invention.

Software 130 may include an operating system, application programs, algorithms, routines, modules, libraries, drivers, and/or databases. Software 130 may be provided via a network, stored locally, and/or on a computer-readable medium (e.g., CD-ROM, DVD-ROM, tape, disk, flash card), as desired. Generally speaking, software 130 may interact with the hardware within system 100 (and possibly hardware outside of system 100), and coordinates the accomplishment of various tasks, such as communication.

Communication apparatus 125 provides a mechanism for system 100 to communicate with another apparatus or system. In a typical implementation, communication apparatus 125 may include various components or blocks, such as a transmitter, a receiver, and/or a transceiver. In conjunction with other components/blocks known to persons of ordinary skill in the art who have the benefit of the description of the invention, such blocks components may facilitate wired communication, wireless communication, or both, between system 100 and other apparatus or systems, as desired. Communication apparatus 125 operates in conjunction with software or algorithms (may be part of software 130) according to the invention, as described below in detail.

Note that FIG. 1 provides merely an illustrative and simplified block diagram or architecture of system 100. Many other variations of system 100 exist, as persons of ordinary skill in the art who have the benefit of the description of the invention understand. One may readily use alternative architectures or structures, and yet take advantage of the inventive concepts, by making modifications that fall within the knowledge of persons of ordinary skill in the art who have the benefit of the description of the invention.

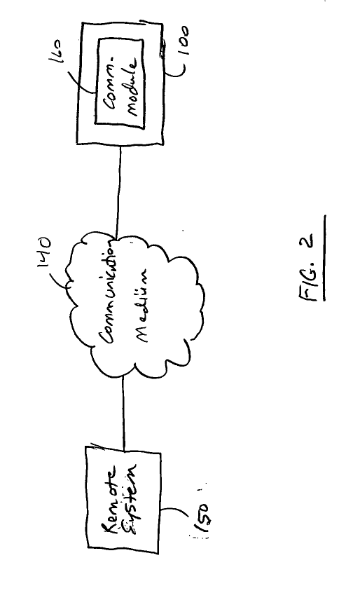

FIG. 2 shows a simplified arrangement of an information handling system according to an exemplary embodiment of the invention communicating with a remote system. Remote system 150 may constitute a variety of systems, such as host systems, centralized computing/data processing systems, servers, and the like, as desired, and as persons of ordinary skill in the art who have the benefit of the description of the invention understand. In some embodiments, remote system 150 may constitute an Internet service provider (ISP), and system 100 may constitute a mobile communication device, such as a PDA, mobile phone, or multi-function device, etc.

Typically, system 100 communicates with remote system 150 via communication medium 140. The communication may be wireless, as desired. Communication medium 140 facilitates communication between system 100 and remote system 150, depending on the type of communication involved or desired. Generally, communication medium 140 may comprise the Internet or similar medium. For wired communication, communication medium 140 may include wires, optical fibers, cables, and the like. For wireless communication, communication medium 140 may include air, vacuum, water, or other media.

System 100 includes communication module 160. Communication module 160 provides a mechanism for the various parts of system 100, such as application programs, to communicate with remote system 150. Communication module 160 can provide that functionality without the user of dedicated, proprietary, or special-purpose servers, either within system 100. Thus, according to one aspect of the invention, system 100 can communicate with remote system 150 directly, without using a dedicated, proprietary, or special-purpose server. An exemplary embodiment of communication module 160 is the NexChange product from Nextworks, Inc., the assignee of the present application.

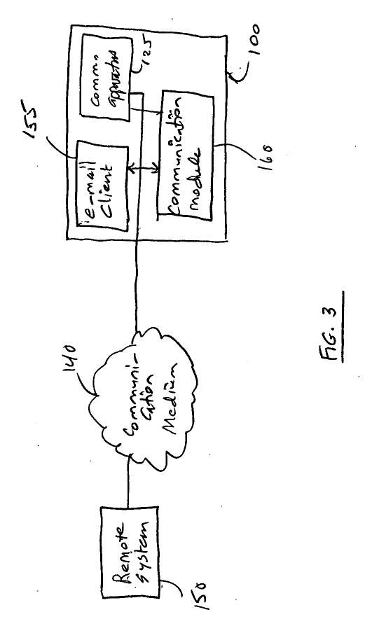

FIG. 3 shows a more detailed block diagram of an information handling system according to an illustrative embodiment of the invention communicating with a remote system in a communication arrangement. In the particular embodiment shown, system 100 includes a communication module 160, and an e-mail client 155. E-mail client 155 facilitates sending and receiving of e-mail by system 100. Examples of an e-mail client program include Microsoft Outlook or Outlook Express.

Communication module 160 communicates with e-mail client 155 and communication apparatus 125. Communication module 160 makes possible the retrieval of e-mail from remote system 150, and communicating generally with remote system 150 as desired. Rather than rely on a proprietary server either within system 100, remote system 150, or elsewhere, as conventional approaches do, communication module 160 can communicate with remote system 150 directly, without the user of a dedicated, proprietary, or special-purpose server.

Thus, communication module 160 can send to remote system 150 e-mail received from e-mail client 155. Communication module 160 can also receive e-mail messages from remote system 150 and provide those messages to e-mail client 155. The user can send e-mail messages, read e-mail messages, or otherwise process information and data related to e-mail via e-mail client 155.

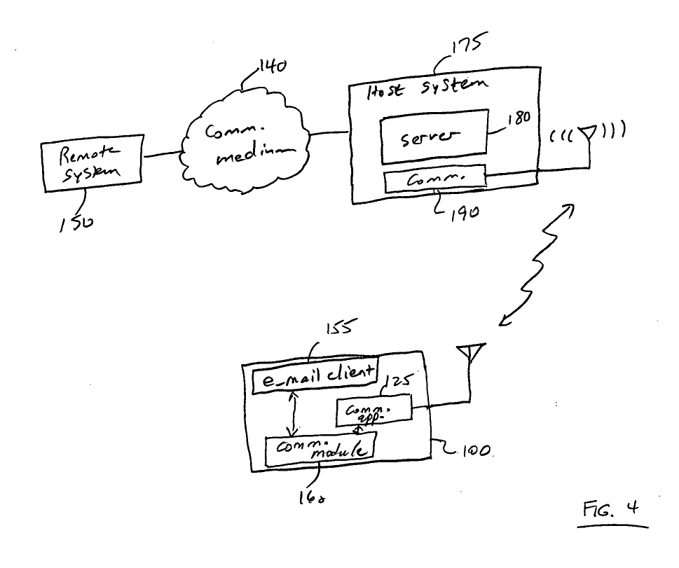

FIG. 4 shows a simplified block diagram of an information handling system according to another illustrative embodiment of the invention communicating with a remote system in a communication arrangement. In this embodiment, system 100 communicates with a host system 175.

System 100 may communicate with system 175 via any desired communication medium, although FIG. 4 shows a wireless communication arrangement. Communication apparatus 190 in system 175 facilitates such communication. Communication apparatus 190 may be similar to communication apparatus 125, as desired.

Host system 175 may constitute a user's base, office, or home system. Host system 175 communicates with remote system 150 via communication medium 140. Host system 175 includes server 180 and communication apparatus 190. Note that, rather than a server, one may generally use a data or information store, as desired.

Host system 175 may retrieve information from remote system 150, and provide the information to system 100 via communication apparatus 190, with or without processing of the information, as desired. System 100 may process the information, as desired, and may provide the information to the user.

Furthermore, host system 175 may receive information from system 100 via communication apparatus 190. Host system 175 may process the received information, as desired. Host system 175 may provide the information to remote system 150 via communication medium 140.

In one example, remote system 150 may be an ISP or other service provider that provides e-mail services to the end-user. Host system 175 may be the user's office computer system. Server 180 serves e-mail receives from remote system 150. Further, server 180 provides e-mail messages to remote system 150. As one example, server 180 may be a Microsoft Exchange Server, well known to persons of ordinary skill in the art.

When the user is in close proximity to host system 175 (e.g., the user is at the office), the user may communicate with server 180 via a workstation, terminal, etc. The user may thus retrieve e-mail from remote system 150, and send e-mail to remote system 150. The user may also use software residing on the desktop, server, or network to communicate with system 100 (e.g., update information and software), as desired.

When the user is not in close proximity to host system 175 (e.g., the user is away from the office), however, the user may use information handling system 100 to communicate with host system 175. In this case, communication module, operating in conjunction with communication apparatus 125, communicates with host system 175.

By using an e-mail client together with communication module 175, the user may process e-mail that resides on server 180 of host system 175. Thus, the user may retrieve e-mail from server 180, and may also send e-mail to server 180. Host system 175 communicates with remote system 150 to process the e-mail, as described above.

Note that, although the illustrative embodiments shown in the figures and described here relate to processing of e-mail, one may apply the inventive concepts to other types of information or services, with or without e-mail, as desired. Examples include contacts, tasks, notes, memos, to-do items, calendars, groupware, and the like. Generally speaking, the inventive concepts are applicable to any information or data store on either, whether on an enterprise system, a simple computer that a remote user wishes to access or manipulate, etc.

Thus, using system 100, the user may communicate with host system 175 to process such information or services. Host system 175 may include server capability aimed at facilitating the processing of such information or services. This mechanism provides the user access to such information or services without the use of proprietary, dedicated, or special-purpose servers and associated hardware and protocols.

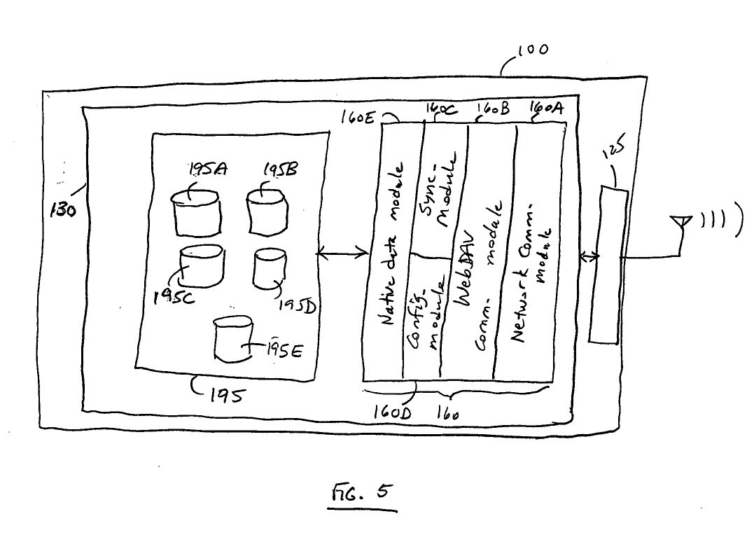

FIG. 5 shows a simplified block diagram of an information handling system according to an illustrative embodiment of the invention. The figure shows the details of communication module 160, as well as database 195 that facilitates the processing of various information or services for the user.

More specifically, database 195 may include a variety of files, file systems, and/or databases that relate to the specific information or services on host system 175 that the user wishes to access and/or process remotely. Examples include calendar database 195A, contacts database 195B, memo database 195C, and to-do database 195D. Database 195 may also include e-mail database 195E. Note that the above databases merely constitute examples, and that one may use a variety of other databases, as desired, and as persons of ordinary skill in the art who have the benefit of the description of the invention understand.

Further, the databases may have a variety of characteristics, such as format, structure, and organization. For example, databases 195A-195D may have a native format that corresponds to the format used by the corresponding databases on host system 175. As another example, database 195E may have a local (to system 100) format, as desired. Many other possibilities exist, as persons of ordinary skill in the art who have the benefit of the description of the invention understand.

Application software or operating system (not shown explicitly) may communicate with database 195 to allow the user to view, access, modify, manipulate, or otherwise process information within database 195. As an example, the user may use an e-mail client to communicate with e-mail database 195E and process information in that database. Note that more than one software may communicate with a database, as desired. Furthermore, one software program may communicate with a number of databases, as desired.

Database 195 communicates with communication module 160. Communication module 160 facilitates communication with host system 175, as described above. Thus, communication module 160 provides a mechanism to access information on host system 175, and to provide information to host system 175. In other words, the user may locally receive information (e.g., calendar information) from a corresponding server on host system 175. The user may manipulate or process the information, to provide the results to host system 175 (e.g., to update the calendar entries).

One may use a variety of protocols in conjunction with communication module 160, as desired. For example, one may use the hyper text transport protocol (HTTP), typically, but not exclusively, on port 80 of the TCP protocol, or the Hyper Text Transfer Protocol Secure sockets (HTTPS) (i.e., secure sockets layer (SSL) protocol, typically but not exclusively, on port 443 of the TCP protocol). Note that, with respect to these examples, one may generally use any TCP port, as desired.

As yet another example, one may use Web-based Distributed Authoring and Versioning (WebDAV) to communicate with host system 175 (as persons of ordinary skill in the art understand, WebDAV traffic can securely ride on top of TCP port 443.) Because WebDAV is an open, non-proprietary protocol, one may use and apply it with relative ease and with relatively low cost. Note that one may use HTTPS with WebDAV, as desired. Use of HTTPS allows secure communication with host system 175.

As another example, one may use remote procedure call (RPC) to communicate with host system 175. Some servers, such as Microsoft's Exchange Server, can employ RPC and/or RPC over HTTPS tunneling, as persons of ordinary skill in the art who have the benefit of the description of the invention understand. The relatively wide availability and use of the Exchange Server makes it readily available to end-users.

Note that the above examples are merely illustrative. As persons of ordinary skill in the art who have the benefit of the description of the invention understand, one may use a variety of other protocols and mechanism, depending on factors such as design and performance specifications, cost, availability, and the like.

Communication module 160 includes several other modules that facilitate performing the tasks of communication module 160. For example, communication module 160 may include network communication module 160A, WebDAV communication module 160B (or other communication module), synchronization module 160C, configuration module 160D, and native data module 160E. The synchronization may take place automatically (according to pre-determined criteria) or manually according to the user's preferences, as desired.

Network communication module 160A provides interfacing with communication apparatus 125, and allows communication with it using a desired protocol. WebDAV communication module 160B allows the manipulation (e.g., transfer, update, storage, change, add or delete, etc.) of information/data over a network to/from dissimilar hosts through any of its many methods or commands such as “search,” “propfind,” “proppatch,” “subscribe,” “notify,” etc.

The particular embodiment shown in FIG. 5 uses WebDAV, as described in detail herein. As noted above, however, in other embodiments, one may use a variety of other protocols and arrangements, such as RPC, as desired, and as described above.

Synchronization module 160C provides a mechanism for synchronizing information in system 100 with the information in host system 175. As an example, the user may synchronize the local calendar in system 100 with the calendar in system 175 and to resolve any differences between the two, perform updates, etc.

Configuration module 160D holds user specific information like the hostname (for example, nxcg.nextworks.com), username, password, subscriptions, ports, encryption information, etc. When a software application is used, it may use the information to facilitate the operation of communication module 160, for example, using the information in the synchronization module 160C.

Native data module 160E provides an interface to information (in native format(s)) in database 195. Thus, native data module 160E facilitates the utilization of the pre-existing databases to store the information synchronized by the information handling system to/from another system, such as host system 175.

Note that one may advantageously add the functionality of communication module 160 in a modular manner. In other words, by adding communication module 160, one may take advantage of its capability of providing communication with the user's host system without using a dedicated, special-purpose, or proprietary server/protocol, etc.

For example, one may add communication module 160 to a Blackberry operating system (OS) based device, Palm OS based device, Symbian OS based device, BREW OS based device, JAVA OS based device, Microsoft Windows Mobile OS based device, etc. In contrast, in a conventional arrangement, the user has to use an intermediate and/or dedicated information exchanger, such as a Blackberry Enterprise Server to obtain information from the user's host system (e.g., obtain e-mail messages or other information from a server, such as the Microsoft Exchange Server, on the host system). The disclosed inventive concepts therefore provide for a more efficient, cost effective, and relatively simple communication mechanism.

The global address list or book (GAL) may be an automatically generated central directory for some or all people in an organization. It may contain information specific to each person, such name, e-mail address, telephone number, location, etc. The GAL may be available to some or all people in the organization.

Subfolders are repositories that can be created below a data store (at a lower level) and in conjunction with any data store (e-mail, calendar, contacts, notes, tasks, and/or public folders). For example, one may create a folder named “Family” below the “Contacts” and place in it individuals that one wishes to separate from the main Contacts folder. This makes the “Family” folder a subfolder of Contacts. Generally, subfolders can be created in conjunction with any folder. Public folders are part of groupware, and may themselves contain subfolders, as desired. They constitute folders that store e-mail, calendar, contacts, notes, or tasks for public view and manipulation (e.g., modification, copying, deleting, viewing, etc.).

Using communication module 160 allows the user to obtain e-mail messages and to send e-mail messages. Rather than, or in addition to, manipulating e-mail, the user may also perform one of more of the following tasks: synchronize calendar events, contacts, notes, tasks, subfolders, global address list (GAL) and/or public folders (or folders generally), without using an intermediate and/or dedicated information exchanger, such as the Blackberry Enterprise Server or other mechanism.

Note that, for the sake of clarity, the arrangements shown in the figures omit several blocks or components that a typical communication arrangement may use or include. Examples include firewalls, switches, hubs, routers, proxy engines or servers, gateways, etc. Furthermore, the communication may take place through one or more of (or portions of one or more of) local area networks (LANs), wide-area networks (WANs), virtual LANs (VLANs), and the like, as desired, and as persons of ordinary skill in the art who have the benefit of the description of the invention understand.

Referring to the figures, persons of ordinary skill in the art will note that the various blocks shown may depict mainly the conceptual functions and signal/information flow. The actual circuit/block implementation may or may not contain separately identifiable hardware for the various functional blocks and may or may not use the particular circuitry/blocks shown.

For example, one may combine the functionality of various blocks into one circuit/functional block, as desired. Furthermore, one may realize the functionality of a single block in several circuits/blocks, as desired. The choice of circuit/block implementation depends on various factors, such as particular design and performance specifications for a given implementation, as persons of ordinary skill in the art who have the benefit of the description of the invention understand. Other modifications and alternative embodiments of the invention in addition to those described here will be apparent to persons of ordinary skill in the art who have the benefit of the description of the invention. Accordingly, this description teaches those skilled in the art the manner of carrying out the invention and are to be construed as illustrative only.

The forms of the invention shown and described should be taken as the presently preferred or illustrative embodiments. Persons skilled in the art may make various changes in the shape, size and arrangement of parts/blocks without departing from the scope of the invention described in this document. For example, persons skilled in the art may substitute equivalent elements for the elements illustrated and described here. Moreover, persons skilled in the art who have the benefit of this description of the invention may use certain features of the invention independently of the use of other features, without departing from the scope of the invention.

1. A system, comprising an information handling system configured to communicate with a host and to exchange information with the host without using an intermediate information exchanger, wherein the information comprises groupware information.

2. The system according to claim 1, wherein the information handling system comprises a communication module configured to facilitate communication with the host.

3. The system according to claim 2, wherein the communication module comprises a network communication module

4. The system according to claim 3, wherein the communication module further comprises a synchronization module.

5. The system according to claim 4, wherein the communication module further comprises a configuration module.

6. The system according to claim 2, wherein the information handling system further comprises a database, and wherein the communication module is further configured to communicate with the database.

7. The system according to claim 6, wherein the database comprises calendar information for an end-user.

8. The system according to claim 6, wherein the database comprises information about a task that an end user is to accomplish.

9. The system according to claim 6, wherein the database comprises contact information.

10. The system according to claim 6, wherein the database comprises information about a memo.

11. The system according to claim 6, wherein the database comprises e-mail information.

12. The system according to claim 6, wherein the database comprises information about one or more of e-mail items, calendar events, contacts, notes, tasks, subfolders, global address list (GAL), and public folders.

13. An information handling system, comprising a communication module, the communication module configured to cause the information handling system to communicate with a second system, and to exchange information with the second, without using a dedicated intermediate information exchanger, wherein the exchanged information comprises at least one of e-mail information, calendar information, contacts information, notes information, tasks information, subfolders information, global address list (GAL) information, groupware information, and public folders information.

14. The information handling system according to claim 13, wherein the communication with the second system comprises Hyper Text Transfer Protocol Secure sockets (HTTPS) over any TCP port.

15. The information handling system according to claim 14, wherein the communication with the second system comprises Web-based Distributed Authoring and Versioning (WebDAV).

16. The information handling system according to claim 13, wherein the communication with the second system uses remote procedure call (RPC).

17. The information handling system according to claim 13, wherein the second system comprises an Exchange Server.

18. The information handling system according to claim 17, comprising a Blackberry operating system (OS) based device.

19. The information handling system according to claim 17, comprising a Palm operating system (OS) based device.

20. The information handling system according to claim 17, comprising a Symbian operating system (OS) based device.

21. The information handling system according to claim 13, further comprising a communication module configured to facilitate communication with the second system.

22. A computer program product, comprising a computer application, adapted for processing by a computer, the application causing the computer to communicate with a host and to exchange information with the host without using an intermediate information exchanger, wherein the exchanged information comprises at least one of e-mail information, calendar information, contacts information, notes information, tasks information, subfolders information, global address list (GAL) information, groupware information, and public folders information.

23. The computer program product according to claim 22, wherein the groupware information comprises e-mail information.

24. The computer program product according to claim 22, wherein the groupware information comprises calendar information.

25. The computer program product according to claim 22, wherein the groupware information comprises information about a task.

26. The computer program product according to claim 25, wherein the computer comprises a wireless mobile device.

27. The computer program product according to claim 22, wherein the host comprises a server.

28. A method of communicating information between a wireless mobile device and a system, the method comprising:
selecting the information;
communicating the information without using a dedicated intermediary information exchanger,
wherein the communicated information comprises at least one of e-mail information, calendar information, contacts information, notes information, tasks information, subfolders information, global address list (GAL) information, public folders information, and groupware information.

29. The method according to claim 28, wherein communicating the information further comprises synchronizing the information between the wireless mobile device and the system.

30. The method according to claim 28, wherein selecting the information further comprises selecting the information from a database in the wireless mobile device.

31. The method according to claim 28, wherein selecting the information further comprises selecting the information from a server within the system.

32. The method according to claim 31, wherein the server comprises an Exchange Server.

33. The method according to claim 32, wherein the wireless mobile device comprises a Blackberry operating system (OS) based device.

34. The method according to claim 32, wherein the wireless mobile device comprises a Palm operating system (OS) based device.

35. The method according to claim 32, wherein the wireless mobile device comprises a Symbian operating system (OS) based device.
